(19) United States
(12) Patent Application Publication
(10) Pub. No.: US 2025/0362672 A1
(43) Pub. Date: Nov. 27, 2025

(54) SYSTEM FOR RULE MANAGEMENT, PREDICTIVE MAINTENANCE AND QUALITY ASSURANCE OF A PROCESS AND MACHINE USING RECONFIGURABLE SENSOR NETWORKS AND BIG DATA MACHINE LEARNING

(71) Applicant: MachineSense, LLC, Baltimore, MA (US)

(72) Inventor: Biplab Pal, Ellicott City, MD (US)

(73) Assignee: MachineSense, LLC, Baltimore, MD (US)

(21) Appl. No.: 18/986,023

(22) Filed: Dec. 18, 2024

Related U.S. Application Data
(63) Continuation of application No. 17/897,986, filed on Aug. 29, 2022, now abandoned.
Application No. 17/897,986 is a continuation-in-part of application No. 16/531,853, filed on Aug. 5, 2019, now abandoned.
Application No. 16/531,853 is a continuation-in-part of application No. 14/934,179, filed on Nov. 6, 2015, now abandoned.
(60) Provisional application No. 62/081,198, filed on Nov. 18, 2014.

(51) Int. Cl. G05B 23/02; G05B 13/02; G05B 19/418

(52) U.S. Cl. CPC G05B 23/0283; G05B 13/028; G05B 19/4184; G05B 23/0278

(57) ABSTRACT

A system for rule management, predictive maintenance and quality assurance of a process using automatic rule formation comprising a plurality of sensors capable of being attached to at least one machine for measuring at least one information about the process and machine operation. The system comprises a server connected to the sensors over a wireless communication network and running a reconfigurable rule management program for identifying and processing the particular process and machine information related to at least one process received from the plurality of sensors. A controller in communication with the server capable of controlling the process based on a rule set by the rule engine. The rule engine automatically detects the normal process data, classifies the received data based on the dynamic rule formed by the rule engine and finds anomalies in the process or machine operation for predictive maintenance and process quality assurance.

### CROSS-REFERENCE TO RELATED APPLICATIONS

This patent application is a 35 USC 120 continuation-in-part of U.S. patent application Ser. No. 14/934,179, entitled “System For Rule Management, Predictive Maintenance And Quality Assurance Of A Process And Machine Using Reconfigurable Sensor Networks And Big Data Machine Learning,” filed 6 Nov. 2015; the priority of the '179 application is claimed under 35 USC 120.

This patent application further claims the benefit of the priority U.S. Provisional patent application No. 62/081,198, filed in the United States Patent and Trademark Office on 18 Nov. 2014, entitled “System for Rule Management, Predictive Maintenance and Quality Assurance of a Process and Machine using Sensor Networks and Big Data Machine Learning”. The specification of the above referenced '179 patent application is incorporated herein by reference in its entirety.

### FEDERAL FUNDING STATEMENT

Not applicable—this invention was conceived and developed entirely using private source funding; this patent application is being filed and paid for entirely by private source funding.

### INCORPORATION BY REFERENCE

Applicant hereby incorporates by reference the following United States Patent Publications Applicant hereby incorporates by reference the disclosures of the following United States patent publications: US 2019/0154032; US 2019/0154469; US 2019/0113280; US 2019/0191287; US 2019/0113281; US 2017/0011298; US 2016/0245279; US 2017/0051978; US 2016/0313216; US 2016/0291552; US 2016/0245686; US 2017/0178030; US 2018/0077522; US 2017/0160328 and US 2016/0245765.

Applicant hereby incorporated by reference the disclosures of the following U.S. Pat. Nos. 9,826,338 and 9,823,289.

### FIELD OF TECHNOLOGY

The present invention relates generally to a system of sensors and multiple sensor data for asset and rule management in an industrial process such as plastic drying, conveying and molding. In general, these systems are applicable to a large number of machines used in similar industrial processes such as conveying, machining of metals and woods, fermentation and various other process engineering. More specifically, it relates to predictive maintenance, rule management and process quality assurance of an industrial process using a reconfigurable sensor network.

### BACKGROUND

Conventional sensors for industrial processes are deployed on a fixed position with the apparatuses or they were employed for a single or multiple process measurement. The conventional industrial sensors are designed to be installed at specific locations inside the process apparatuses, for which specialized sensor housings are used which results in increased overall cost of the sensor device and system. Also, different devices require different types of specifically designed conventional sensors and they are wired to external communication and control devices for measurement, analysis and control of the process.

Predictive analytics uses previously real time data and outcome is based on the pattern detected in the data collected in the past. It includes two data type: Training and Prediction set. Using a predictive model, a user can predict the unknown or future outcome. In big machine data collection, either automated or semi-automated techniques can be used to discover previously unknown patterns in data, which includes relationships between desired “prediction” such as a particular failure and machine parameters. A process in an industry is carried out by a single machine or a system of machines. A set of sensors of a same type or different types are attached to the machines for sensing both the process and the machine parameters such as sound or vibration from machines to check the maintenance condition of the machines. Hence, when multiple sensors are used to collect different process or data for predictive maintenance, the relationship between the systems having the sensor should be well defined.

With the advances in the sensor technology, the sensors can be detachable, mobile and reconfigurable. They can be assigned to any machine and any process in any given time. The sensors can be used to measure one or multiple process parameters and the same sensor can perform multiple functions such as predictive maintenance and process quality check. The measured data can be processed for several reasons such as meaningful information for predictive maintenance issues of a machine. In most of the factories, there exists multiple processes using same or different sets of machines.

Therefore to use a reconfigurable sensor network where the same sensor can be allocated to different machines and process, the user has to specify which are the measured quantities by the sensor as it can measure a variety of values resulted from different sensors deployed for different machines. To make the sensor reconfigurable, it should be in terms of physical reconfiguration, a logical reconfiguration, or reconfiguration of a mode of operation of the sensor. The reconfigurable sensors can be used to manage collecting data/information about the machine as well as process and/or modify calibration and/or changing other attributes of one or more sensors using predefined rules. The reconfigurable sensor can perform a different behavior; provide a different output and it should be able to measure different classes. The reconfigurable sensor itself can be used to feed data. The reconfigurable sensor can be configured to provide different types of information to different user classes. Thus, agility to allocate sensors to different machines, sub-assembly, process and prediction must be achieved to use the sensor data effectively for predictive analysis of machine data

The existing process control and quality programs which are designed to address a sensor fixed on a location to measure a predetermined set of process parameters cannot be employed to automatically detect different processes inside a machine solely from measured values of the sensors. Moreover the system cannot automatically detect and distinguish between the machine parameters for predictive maintenance and the process parameter measured by the sensors. Hence, different sensors installed for process measurement and machine data including sound and vibration measurement may enforce the data to be processed separately using two or more independent programs running in a server for process management and predictive maintenance. The separately processed data increases the overall cost for sensors and systems and also leads to under-utilization of the sensors and sensor data.

The above said sensors may be integrated using integration platform that may include rule engine module. The interface may include a rule creation interface. The data analysis module analyzes the collected data and metadata to determine specific semantic label or context relevant to the machine. The rule management module enables configuration, adjustment, and interaction with the sensor devices based on collected data. Since the data amount is very large, and each piece of data must be matched with a set of rules in the big machine data, extremely severe necessity has been raised for data filtering (rule match) engines of application gateways. The system may store a large amount of state information, so it is difficult to achieve a rapid and efficient effect for matching events. In conventional systems for changing a rule, the hardware must be replaced and/or reinstalled. The software coding on the already existing hardware requires complex steps to make the change. Hence a new method and system is required for collecting data and to use commands for modifying the existing rules or to create new rules in the various configuration of sensors without changing hardware devices.

In conventional systems, mobile middleware facilitates the rapid deployment of adaptive applications in wireless sensor networks but with the constraint of injecting special programs for application specific tasks. Major drawbacks in conventional system include the high level of dynamics within the network in terms of changing wireless links and node hardware configurations, wide variety of hardware present in these networks, and extremely limited computational and energy resources available. Hence there exists a need to create a structured assignment between machines, sensors and machine process using simplified architecture. Programs are developed that can connect different mobile applications, machine and systems in the sensor networks and big data machine learning environment.

U.S. Pat. No. 8,150,340 B2 discusses a heating control system, comprising temperature transducer element having a downstream voltage transformer. A logic assembly is coupled to the energy storage device and has sequence control. A data transmission unit is coupled to the logic assembly. A sensor, coupled to the logic assembly, measures ambient parameters. It uses the logic assembly to be connected to at least one sensor. Measurement data from the at least one sensor can then be recorded and read by the logic assembly applied to the transmission message, interrogating one or more sensors. The patent discusses a logic based system and mechanism. Further, the application fails to disclose reconfigurable engine and rule management in big data machine learning.

U.S. Pat. No. 5,150,289A discusses a system for closed-loop control of equipment that performs a process and responds to a controlled variable signal to vary a measurable characteristic of the process. An error signal is generated as the difference between the mean signal and a signal representing a target value of the monitored characteristic, divided by the value of the standard deviation signal. The system monitors the error signal to detect selected changes in the process by generating two disparate or extreme-value accumulation signals. One is a high-value accumulation signal that represents time-wise summation of successive values of the difference between the error signal and a predetermined high slack value. The other is a low-value accumulation signal that represents a time-wise summation of successive values of the difference between a negated error signal and a predetermined low slack value. The high slack value and the low slack value which may, for example, be specified by the operator at run time, are independent of one another. That is, although the operator may set the values equal to each other, in principle they can be set to different levels. This independence of the disparate accumulation signals permits enhanced accurate control of a wide range of manufacturing processes. This patent amongst others fails to show any means of collecting real time data and also fails to adapt or learn.

It is evident from the discussion of the aforementioned prior arts that none of them pave way for rule management, predictive maintenance and quality assurance of a process and machine using sensor networks.

Therefore, there exists a need for an automated system that would allow the use of same set of sensors for process and predictive maintenance data measurement in a process. The needed system would be able to distinguish between the measured process and machine maintenance/state parameters for automated process management and predictive maintenance of the system using reconfigurable sensors. Moreover the needed system would be able to detect an anomaly in the process or machine by comparing against a normal standard test value set by an automated rule engine. The needed system would be able to automatically set different rules for the optimal operation of the process and the machine. Further the needed system would be able to operate independently without assistance from the system controllers (such as Profinet from Siemens) for automated detection of the process, machine parameters, rule setting and predictive maintenance and process quality assurance. The present invention accomplishes these objectives.

This disclosure extends a new concept of “Machine Wearable Sensors” as opposed to sensors that goes inside the process of a machine. The basic idea is to plug sensors outside the machine and try to investigate machine and process issues from “Wearable sensors” as the concept leads to reduction of cost, ease of maintenance and ease of data communication since they are not deployed as “in process” sensors.

### SUMMARY

Disclosed are a method, an apparatus and/or a system for rule management, predictive maintenance and quality assurance of a process and machine using sensor networks and big data machine learning.

In one aspect, the present invention is a system for the purpose of rule management, predictive maintenance and process quality assurance of at least one process or in general multiple processes using automatic rule formation. The system comprises a plurality of sensors capable of being attached to at least one machine or multiple machines, in general, for measuring information about at least one process or multiple processes in general or maintenance information about the machine. The multiple sensors attached to the machines are connected to a server of the system via a wireless communication channel. The servers are connected to at least one controller for the machines or the processes via the same wireless network or a separate dedicated wireless network. The server receives the information collected by the multiple sensors over the wireless channel. The controller is connected to a reconfigurable engine that is either associated with the server or with a mobile application connected to the server over a wireless network. The multiple sensors attached to the machines performing one or different processes can measure process parameters and predictive maintenance parameters. The reconfigurable engine of the present embodiment automatically collects and classifies the information regarding the process parameters and the predictive maintenance parameters from the sensors into individual stream with enough data “tuplet” to do analytical processing for extracting useful information on sensor data for predictive maintenance and process quality assurance.

In another aspect, reconfiguring a sensor or a rule that governs the sensor analytic is deployed via a mobile application that syncs up a local reconfigurable database with a server database for rule and sensor asset management.

In another aspect of the present invention, the server can include an algorithm to auto detect the type of process or the machine predictive maintenance data from the measured process or machine parameters. The reading from one sensor can act as a reference for others for auto-discovery of a process without having data or receiving an update from the controller. The controller for the process can be mapped to the reconfigurable engine running in the server for classifying the predictive maintenance data and controller data to perform analytical processing for extracting useful information on sensor data for predictive maintenance and process quality assurance. A process discovery algorithm associated with the server uses one or multiple process data as reference for discovering a process automatically without controller data. A set of fixed or dynamic rules are created from normal state of operation data assigned to a particular process or predictive maintenance and the process were run for obtaining an ideal normal operating mode called “Test Mode” and the data can be used to compare and detect an anomaly process with anomaly being identified and rules for identifying a normal versus a particular anomaly is created automatically within the server program. Thus the system can be used for automatic discovery of rules, which can be further utilized for predictive maintenance, automatic process identification and process quality assurance.

Alternative embodiments of the invention have other aspects, elements, features, and steps in addition to or in place of what is described above. These potential additions and replacements are described throughout the rest of the specification.

### BRIEF DESCRIPTION OF THE DRAWINGS

FIG. 1 is a schematic view of a system for performing predictive maintenance and process quality assurance of at least one process using at least one sensor device according to a preferred embodiment of the present invention.

FIG. 2A is an exemplary screen shot showing sensor calibration process for magnetometer values, according to one embodiment.

FIG. 2B is an exemplary screen shot showing magnetometer values after sensor calibration, according to one embodiment.

FIG. 3A is an exemplary screen shot showing base lining options, according to one embodiment.

FIG. 3B is an exemplary screen shot showing starting baseline operation, according to one embodiment.

FIG. 4 is an exemplary screen shot showing after calibration of PM gauge (Reactive Power) according to one embodiment.

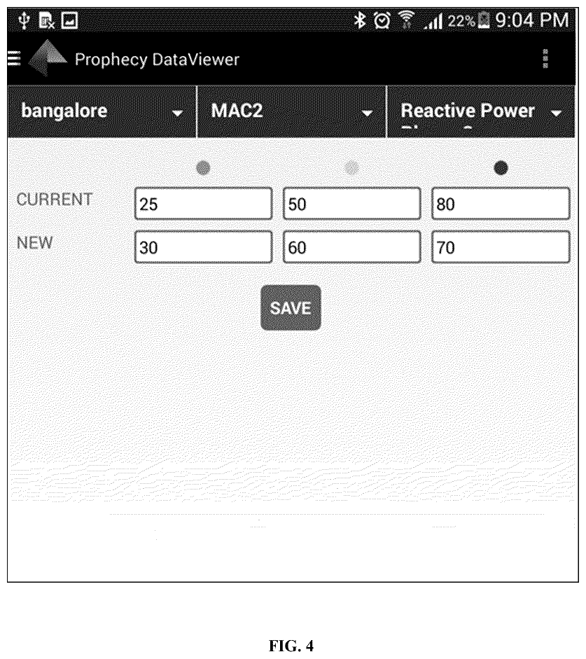

FIG. 5A is a diagrammatic representation of a flexible and dynamic association system, according to one embodiment.

FIG. 5B is schematic view of a system, according to one embodiment of the invention.

FIG. 6A is an exemplary screen shot of a zone sub assembly and machine collector, according to one embodiment.

FIG. 6B is an exemplary screen shot of a sensor discovery, according to one embodiment.

FIG. 6C is an exemplary screen shot of the sensor detection and mapping, according to one embodiment.

FIG. 6D is an exemplary screen shot of the sensor mapping to machine, according to one embodiment.

FIG. 7 is a diagrammatic representation of three tier architecture for calibration and value management, according to one or more embodiments.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

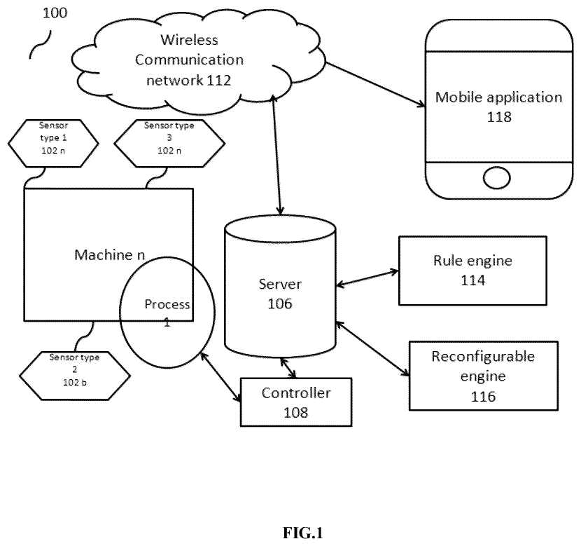

FIG. 1 illustrates a system 100 of predictive maintenance and process quality assurance of one or more industrial processes, according to one embodiment. The system 100 comprises an N-number of sensors 102 (Example: 102A-102F) capable of being attached to N-number of machines 104 (Example: 104A-104C). The sensors measuring information process data and/or information about the N-number of machines 104. The plurality of sensors 102 may be of portable type that can be attached to various machines or can be associated with various processes for measuring the process data and/or machine information. In some instances, the plurality of sensors 102 may be fixed permanently to the plurality of machines 104 for measuring the process and/or machine information. The multiple sensors 102 attached to the plurality of machines 104 are connected to a server 106 of the system 100 via a wireless communication channel 112 such as, but not limited to, Bluetooth, low energy Bluetooth and/or Zigbee mode of wireless communication. The server 106 may be connected to one or more controllers 108 for the N-number of machines 104 via the wireless network 112 and/or a separate dedicated wireless network. Thus, the server 106 may receive the information collected by the plurality of sensors 102. The controller 108 may be connected to a reconfigurable engine 116, either associated with the server 106 and/or with a mobile application 118. The mobile application 118 may be associated with the server 106 over a wireless network 112. The plurality of sensors 102 attached to the N-number of machines 104 performing one or more different processes may measure multiple parameters such as process parameters and predictive maintenance parameters for the associated machines. Therefore, the plurality of sensors 102 fixed to and/or retrofitted to the N-number of machines 104 may perform multiple functions including predictive maintenance and process quality checks. The reconfigurable engine 116 may automatically collect and classify information regarding process parameters and predictive maintenance parameters from the plurality of sensors 102. The collected information may be classified into an individual stream with enough data “tuplet”. Analytical processing for extracting useful information may be performed on sensor data based on the classification. The analytical processing may assist in predictive maintenance and/or process quality assurance.

According to another embodiment of FIG. 1 describes a plurality of sensors 102 that are capable of performing multiple functionalities including predictive maintenance and process quality check of the N-number of machines 104. The N-number of machines 104 running in a factory. The system 100 further comprises server 106 associated with the plurality of sensors 102 over a wireless communication network for processing the plurality of information received from the plurality of sensors 102. The server 106 may include an algorithm to auto detect types of processes and/or machine predictive maintenance data. The server 106 may process the plurality of data through one or more machine learning algorithms. The data may be sent to at least one controller 108 in communication with the server 106. The controller 108 may control one or more processes based on data received from server 106. The reading from at least one sensor 102 may be used as reference for auto-discovery of process without having data and/or an update received from the controller 108. In some instances, processes and control readings may be identified from the plurality of sensors 102 and controllers 108 of the machine respectively. The sensors and controllers 108 may be connected to the server

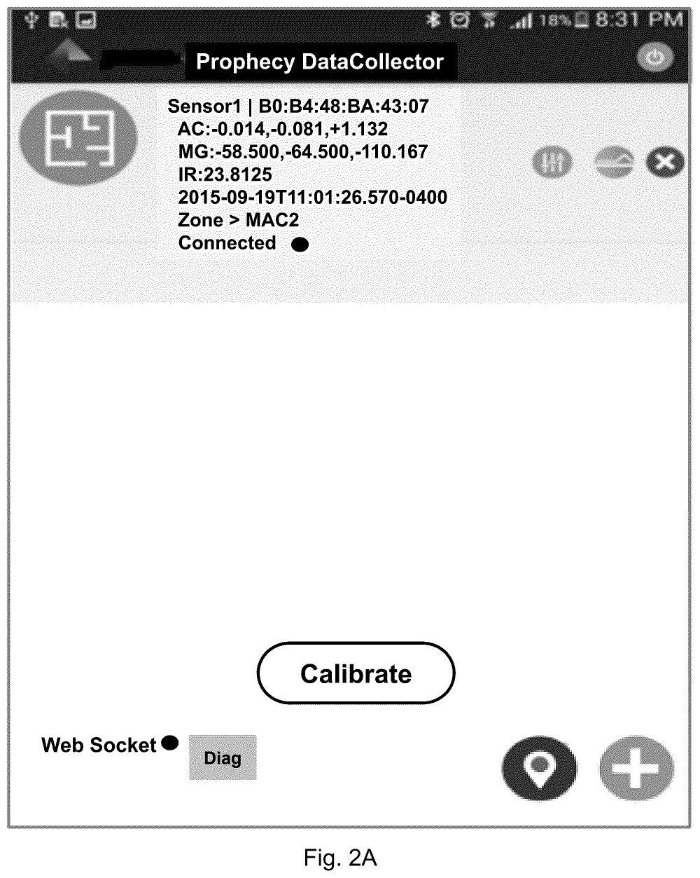

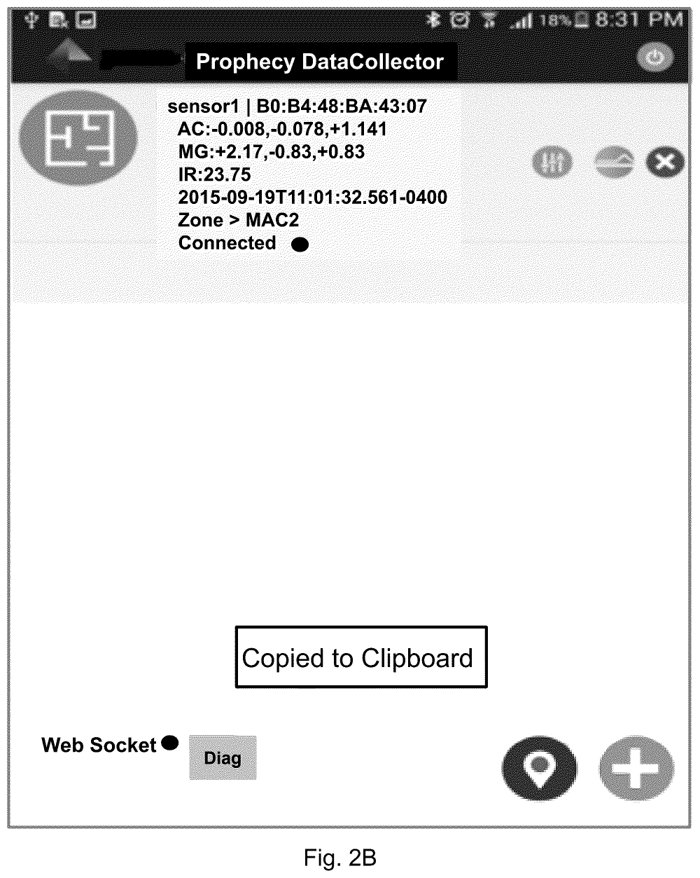

106. An algorithm associated with the server 106 performs a decision function. At least one controller 108 associated with at least one process may be mapped into a reconfigurable engine 116 running in at least one server 106. Mapping may lead to classifying at least one predictive maintenance data and at least one controller data. Further, the classifying may lead to analytical processing for extracting useful information on sensor data for predictive maintenance and process quality assurance. In one or more embodiments, the reconfigurable engine 116 may be associated with a mobile application 118 running in a smartphone, a tablet and/or a portable computer device associated with the server 106. The mobile application 118 may process the plurality of inputs from the sensors and configure the controller 108 to control the one or more processes for automatic predictive maintenance and process quality assurance. FIG. 2A illustrates a screenshot showing a sensor calibration, according to one embodiment. Each of the N-number of sensors 102 may output one or more kinds of parameters such as the process parameters and the predictive maintenance parameters for associated machines. A magnetometer may be configured to provide a sensor vector corresponding to the magnetometer's orientation relative to a magnetic field. The sensors 102 may have a combination of output ‘r’ vectors based on orientation. FIG. 2A illustrates magnetometer values after sensor 102 calibration.

FIG. 2B illustrates magnetometer values after sensor calibration, according to one embodiment. FIG. 2B is a diagrammatic representation of sensor calibration as shown on a user interface according to one embodiment.

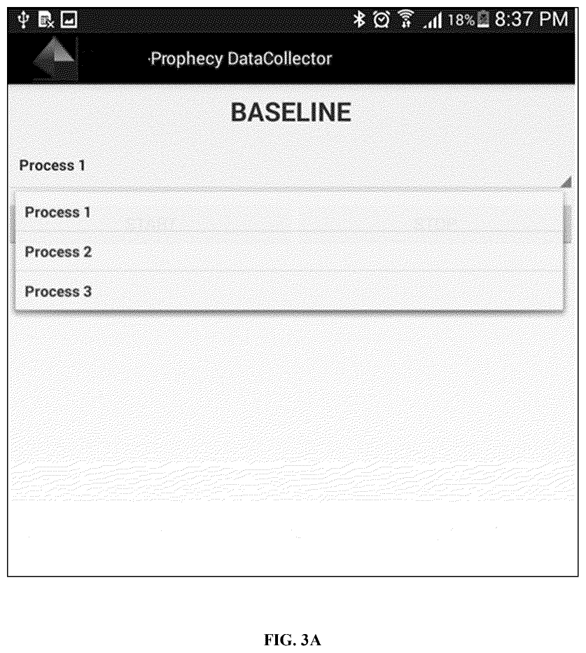

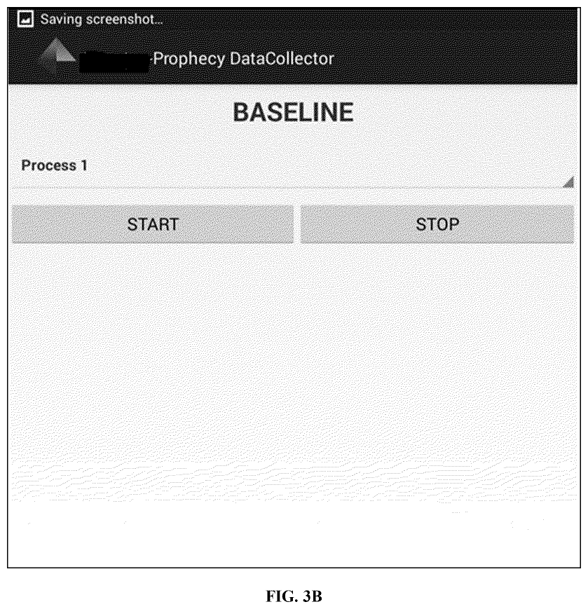

FIG. 3A illustrates a system 100 that generates various statistical properties of the collected machine and process data, according to one embodiment. Three levels of calibration of system may be possible in the system 100. The three levels are predictive maintenance gauge calibration, baseline calibration and sensor calibration. According to one example embodiment, sensor calibration may be described. The FIG. 3A illustrates base lining options. In the baseline calibration, calibration of machine and vibration sensors may be combined. The sensor calibration may measure vibration levels produced by one or more models of the multiple machines. Sensors may be of different types measuring multiple parameters such as vibration, acceleration, etc., The multiple parameters may help in performing multiple functionalities including predictive maintenance of the N-number of machines 104 and process quality check in a factory running multiple processes using the same system of machines.

FIG. 3B illustrates a screen shot showing a baseline operation starting position, according to one embodiment. The normal and/or baseline operation of machines 104 may be measured by the sensors 102. If the mode is manual base lining, a user may select one or more of a machine state and/or an attribute for a particular selected machine 104. If the mode is automatic base lining, the data associated with one of the machines in the N-number of machines 104 may be used as a reference.

In the base lining process in a starting (progress) state, according to one embodiment a plurality of sensors 102 may be mounted on one or more of the N-number of machines 104. Sensors may be assigned to collect temperature, vibration, current, voltage, phase lag, vacuum, magnetic field, gyroscopic data and other information. The collected machine and process data may be fed to a server 106 which analyzes and stores the data. The server 106 may be associated with a machine learning algorithm. The collected data may be classified into base line data. The base line data may primarily include one or more of meta data and/or “test” data. Here the baseline data refers to data from a normally operating machine (normal condition) and/or a condition in a good machine. Test data may be classified according to the requirements of the testing. Meta database of the sensor 102 may be created in the server 106. Various useful statistics may be obtained from raw and/or transformed data to differentiate between baseline and test data.

Parameters or attributes of the collected machine and process data for base lining may show different linear behavior. Once baseline statistics start, the system performs base lining at different points. The system 100 may initiate start baseline and end baseline process to measure the machine and process data across the plurality of sensors 102. The duration of the test must be defined for the machines 104. After completion of base line testing, the system 100 may store the data in the format of baseline polynomial for further analytics.

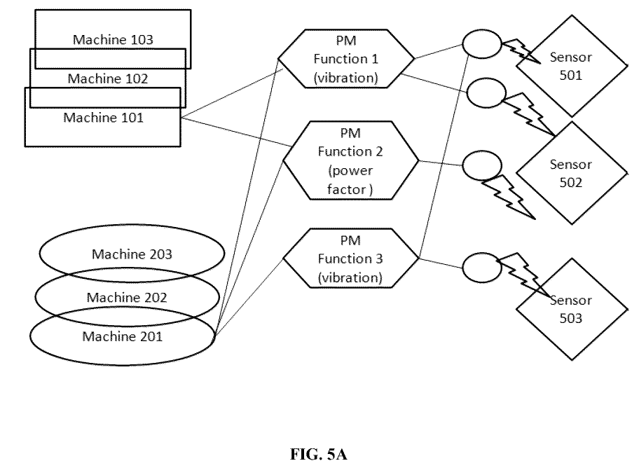

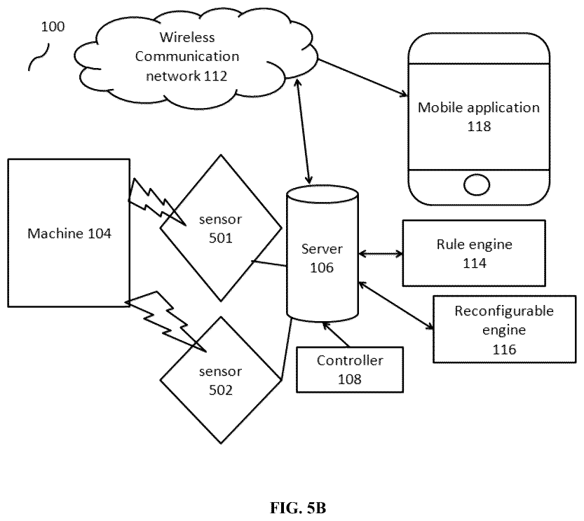

FIG. 5A shows a schematic view of mobile middleware, according to one embodiment. In one or more embodiments, one or more of flexible and dynamic association of mobile middleware may be formed. A factory may have many zones with machines of different sub assembly types. The factory setup comprises of different zones wherein machines of each zone have machines of different sub assembly types. For example, sub assembly type 1 may have multiple machines that may be selected from the group of pumps and/or any similar type of machines. In another example, sub assembly type 2 may include multiple machines that may be selected from the group of dryers and/or any similar type of machines. Multiple processes may be carried out by the plurality of machines in different sub-assemblies. The relationship between the machine data and process information may be defined by the rule engine associated with the at least one server.

In the above said preferred embodiment of FIG. 5A includes a plurality of sensors 501 capable of performing multiple functionalities including predictive maintenance of N-number of sub-assemblies and process quality check in a factory running multiple processes. The system of the present invention further comprises at least one PM function such as vibration and power factor. Plurality of machines connect over a wireless communication network for processing the plurality of information related to one or more processes received from the plurality of sensors 501. The PM function may need a set of collectors for collecting one more ore of the machine and process data. The readings from plurality of machines performing different processes may be sent to a fixed set of collectors having a defined function. The multiple processes reading from plurality of sensors 501 may act as reference for others. The reference may be associated with an auto-discovery of process without having data and/or update from the controller. In some instances, processes may identified from sensors reading and control. At least one process may be mapped onto a reconfigurable engine running in one or more servers. The system may form a fully automated processing system, which can measure the system parameters, identify different parameters measured using the same sensors and/or different sensors, comparing the values with nominal values and finding anomalies in a particular process and/or machine. Further, the automated system may create dynamic rules based on the normal values and can reconfigure the system and the process automatically for predictive maintenance/Still further, automatic process identification and process quality assurance may be achieved through the automated system. Moreover, a user may monitor and/or control the process (the system) remotely using portable devices having a mobile application configured to interface with the sensor values and having the reconfigurable rule program associated with the portable device.

FIG. 5B illustrates a number of readings from the plurality of sensors 501 performing different processes being transferred to the server 106. Running the asset assignment algorithm for each sensor 501 may be viewed as a shared and reconfigurable asset. A process discovery algorithm is associated with the server 106 where one or more process data may be a reference for discovering a process automatically without controller data. A set of fixed and/or dynamic rules may be created from normal state of operation data assigned to a particular process and/or predictive maintenance. Rules may be created to separate data that differentiates a good machine from a bad machine, a machine due for repair or maintenance and a good process from a bad process. First the plurality of machines 104 and process were run for obtaining an ideal normal operating mode called “Test Mode” to obtain normal test data and the data can be used to compare and detect an anomaly process. With the anomaly being identified and rules for identifying a normal versus a particular anomaly is created automatically within the server program. Thus, the system 100 can be used for automatic discovery of rules.

Further, system 100 may be utilized for predictive maintenance, automatic process identification and process quality assurance. Machine learning classification algorithms like support vector machines (SVM), K-mean, Neural Network, Random Forest, Logistic Regression, Decision Tree, p-Tree may be used on the data collected during test period. Further, rules may be generated from learning algorithms.

FIG. 5B illustrates the system 100 of the present invention, according to one embodiment. The system 100 acts as an asset and rule management system. The system 100 may be capable of measuring data of the processes and to identify the processes from the collected information, identify the state of the machine and/or equipment from the collected information, distinguish between process and machine parameters automatically, generate dynamic rules based on a reconfigurable engine 116 and the measured process, machine parameters, and automatically detecting anomalies in any process or machine by comparing with normal values as per the dynamic rule, etc.

Further the system 100 may be used for predictive maintenance, automatic process identification and process quality assurance based on the automated dynamic rules formed using the reconfigurable engine 116 associated with the server 106. Thus, the system 100 may form a fully automated processing system. The fully automated processing system may measure parameters of the automated processing system, identify different parameters measured using the same sensors and/or different sensors, compare the values with nominal values and finding anomalies in particular process and/or machine. Further, the automated system may create dynamic rules based on the normal values and can reconfigure the system 100. Also, the automated system may automatically process for predictive maintenance, automatic process identification and process quality assurance. Moreover, a user can monitor and/or control the system 100 remotely using a portable device having a mobile application configured to interface with the sensors and having the reconfigurable rule program running on the portable device.

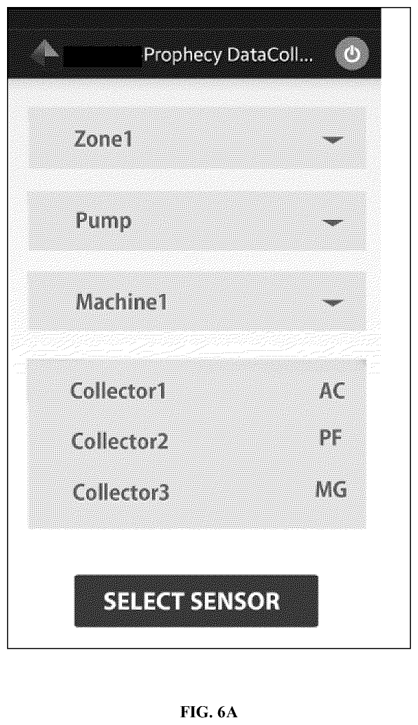

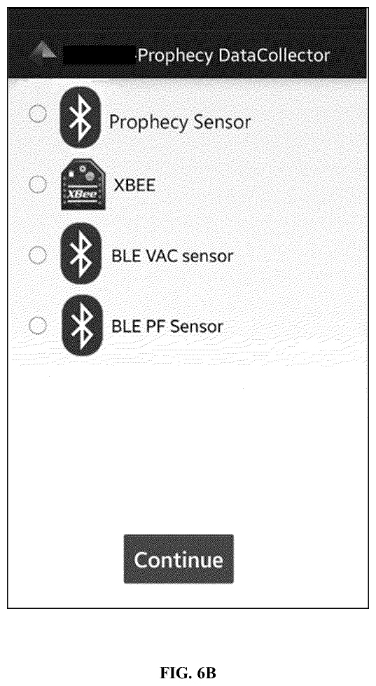

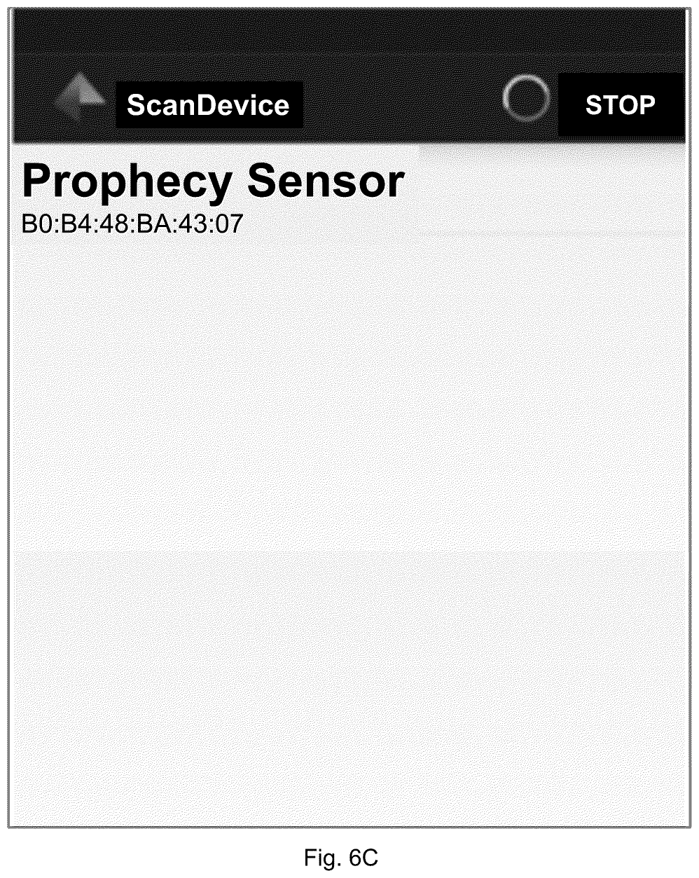

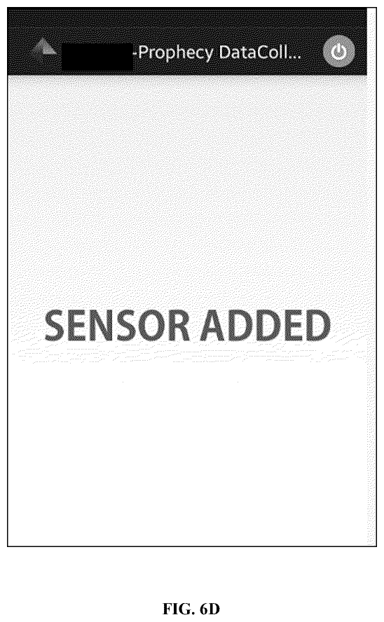

FIG. 6A illustrates a screen shot of sub assembly zone of multiple machine collector, according to one embodiment. An illustrative screen layout on the user interface is shown. The module can be operable by selecting from icons denoting zone, pump and machine accordingly. The calibration screen layout provides for display and selection of various parameters, including collector 1, collector 2, collector 3, which represents collected data, attributes, values and parameters respectively.

FIG. 6B illustrates a screen shot showing an illustration of sensor discovery for reconfigurable engine algorithm executed by the server, according to one embodiment. The sensor may be selected from a group of Prophecy sensors, Zigbee, BLE VAC (vacuum) sensor, Bluetooth PF (power factor) sensor and a combination thereof. The systems process the plurality of input from the sensors and configure the controller to control the process or processes, for automatic predictive maintenance and process quality assurance.

FIG. 6C illustrates a screen shot of sensor detection and mapping, according to one embodiment. Determining relative locations of sensor nodes with the affixed multiple machines and mapping relative locations of the sensor nodes with respective plurality of machines and processes. Every sensor may have different values compared to other type of sensor configurations. The different values may be due to different versions of sensors and/or aging of the sensor. The system allows calibration of the sensor based on a fixed offset chosen by user.

FIG. 6D, a screen shot illustrating the sensor mapping to the machine according to one embodiment of the invention. A user interface may be selected from a group of systems like mobile device, portable device, wireless communication device or any laptop, tablet, desktop or any combination thereof. Thus, the system may form a fully automated processing system, which can measure its own parameters, identify different parameters measured using the same sensors or different sensors, compare the values with nominal values and find anomalies in a particular process or a machine, create own dynamic rules based on the normal values and can reconfigure the system automatically for predictive maintenance, automatic process identification and process quality assurance. Moreover, a user may monitor and/or control the process or the system remotely using a portable device having a mobile application configured to interface with the sensors and having the reconfigurable rule program running on it.

Thus a system for rule management, predictive maintenance and quality assurance of a process using automatic rule formation comprising a plurality of sensors capable of being attached to one or more machines for measuring one or more information about the process and machine operation is described according to the disclosure. A server may be associated with one or more sensors over a wireless communication network. The server may be running a reconfigurable rule management program for identifying and processing the particular process and machine information related to the one or more processes received from the plurality of sensors.

A controller in communication with the server may be capable of controlling the process based on a rule set by the rule engine. The rule engine automatically detects the normal process data, classifies the received data based on the dynamic rules formed by the rule engine and finds anomalies in the process and/or machine operation.

In one or more embodiments, a method and system of three tier architecture for calibration and value management may include calibrating sensors based on an auto calibration signal, base-lining one or more of a sensor data and a machine data through a combination of database architecture, data training architecture, and a base-lining algorithm. Further, the three level calibration may include calibrating a Predictive maintenance gauge.

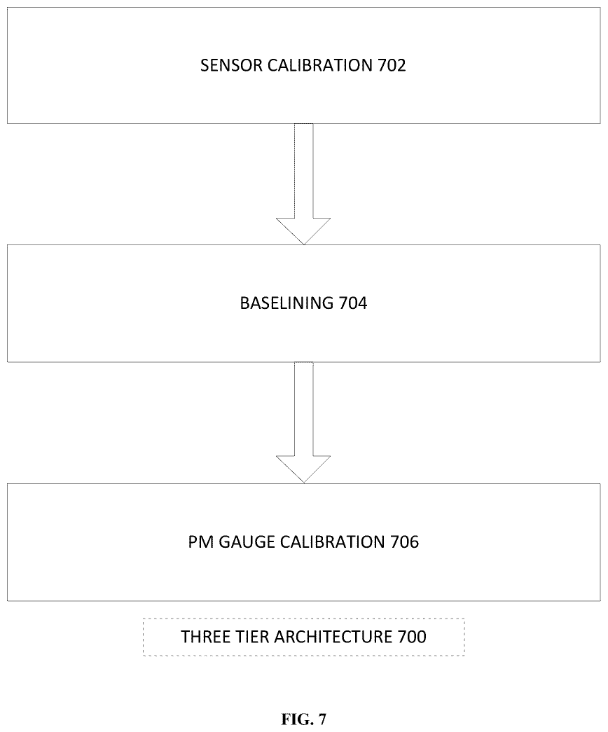

FIG. 7 is a diagrammatic representation of three tier architecture for calibration and value management, according to one or more embodiments. The three tier architecture 700 may include sensor calibration 702, base lining 704 and Predictive Maintenance (PM) gauge calibration 706.

The sensor calibration 702 may be based on an auto calibration signal received from another system. The sensor calibration 702 may be needed due to aging sensors and electronics. The baselining 704 may include a combined calibration of a machine and vibration sensors. The baselining 704 may be necessary to increase compatibility with older machines when housing and model positioning remain unchanged. The baselining 704 may include calibrating vibration levels produced by one or more machines during installation of sensors onto machines. The calibration of the predictive maintenance gauge 706 may be necessary to a large variety of users. Different users may perceive a predictive maintenance scale differently. Therefore, ranges associated with predictive maintenance states may be adjusted according to a perception of a user as opposed to a factory default.

In one or more embodiments, mobile middleware may associated with the three tier architecture. The mobile middleware may facilitate rapid deployment of adaptive mobile applications in wireless sensor networks. The mobile middleware may allow calibration and value management at an increased pace as compared to conventional systems. The mobile middleware may be associated with mobile applications.

In one or more embodiments, a three tier architecture of calibration, i,e, sensor, sensor with machine and sensor, machine with predictive algorithm may be used to create an unified IoT (Internet of Things) based approach to get robust and reliable results for predictive maintenance and process simulation values.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. Apparatus for quality assurance of at least one industrial process using rule formation from sensor data comprising:
a) a plurality of sensors attached to a machine for measuring information about the industrial process and operation of the machine;
b) a server connected to the sensors over a wireless communication network, for processing the information related to the industrial process received from the sensors;
c) a controller in communication with the server, the controller being capable of controlling the industrial process based on data received from the server,
d) a program running on the server for forming automated rules for predictive maintenance and process quality assurance from data received from the sensors; and
e) a reconfigurable engine running the server receiving output from the controller for classifying predictive maintenance data and controller data and performing analytical processing on information extracted from sensor data for predictive maintenance and process quality assurance of the machine.

2. A method of maintaining interoperability in an industrial process having rule management, predictive maintenance and quality assurance aspects, comprising:
a) configuring a plurality of sensors attached to a machine operating as a part of the process for measuring information about the process and operation of the machine;
b) configuring a server connected to the plurality of sensors over a wireless communication network for processing the plurality of information related to the process received from the plurality of sensors;
c) configuring a controller in communication with the server, the controller being capable of controlling the process based data received from the server;
d) receiving on a rule engine interface of the server a selection of data associated with the machine measuring information about the process machine operation;
e) a program running in the server for forming automated rules from the data received from the plurality of sensors, the automated rules being applied for predictive maintenance and process quality assurance;
f) mapping output from the controller for the process into a reconfigurable engine running the server for classifying predictive maintenance data and controller data to perform analytical processing; and
g) extracting useful information from sensor data and performing an analytical processing for predictive maintenance and process quality assurance on the server.

3. A system for obtaining rule management, predictive maintenance and quality assurance information for an industrial process from sensor data, comprising:
a) a plurality of sensors capable of being attached to a machine for measuring information associated with the industrial process and the machine operating as a part of the process;
b) a server connected to the plurality of sensors over a wireless communication network, for processing the information related to the industrial process received from the plurality of sensors;
c) a controller associated with the server, for controlling the industrial process based on data received from the server,
d) a program running in the server and forming automated rules from the data received from the plurality of sensors, the automated rules being for predictive maintenance and process quality assurance;
e) wherein output from the controller associated with the industrial process is mapped into a reconfigurable engine running in the server classifying predictive maintenance data and controller data to perform analytical processing on extracted information from the sensor data;
f) wherein the analytical processing is for predictive maintenance and process quality assurance; and
g) wherein the server includes multi-tier architecture for:
i) calibrating the plurality of sensors based on an auto calibration signal;
ii) base-lining the sensor data; and
iii) calibrating a gauge associated with the predictive maintenance information.
